(19) United States
(12) Patent Application Publication
(10) Pub. No.: US 2018/0254642 A1
(43) Pub. Date: Sep. 6, 2018

(54) Multi-Device Charging Assembl

(71) Applicant: Roy Corrie, Itasca, IL (US)

(72) Inventor: Roy Corrie, Itasca, IL (US)

(21) Appl. No.: 15/446,394

(22) Filed: Mar. 1, 2017

(51) Int. Cl. H02J 7/00

(52) U.S. Cl. CPC H02J 7/0027; H02J 7/0045

(57) ABSTRACT

A multi-device charging assembly for a vehicle includes an adaptor that is configured to operationally couple to an electrical receptacle of the vehicle. A plurality of ports is positioned in the adaptor. Each of a plurality of cables has a first end that is configured to operationally couple to a respective port. Each cable has a second end that comprises a plurality of first connectors, each of which is configured to couple to a charging port of an electronic device. A plurality of first fasteners is configured to couple to a surface of the vehicle. The first fasteners are positioned to couple to a respective cable such that the second end of the respective cable is positioned proximate to a passenger seat of the vehicle. A respective first connector is configured to selectively couple to the charging port of the electronic device to charge a battery of the electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98

The disclosure and prior art relates to charging assemblies and more particularly pertains to a new charging assembly for a vehicle.

### BRIEF SUMMARY OF THE INVENTION

An embodiment of the disclosure meets the needs presented above by generally comprising an adaptor that is configured to operationally couple to an electrical receptacle of the vehicle. A plurality of ports is positioned in the adaptor. Each of a plurality of cables has a first end that is configured to operationally couple to a respective port. Each cable has a second end that comprises a plurality of first connectors, each of which is configured to couple to a charging port of an electronic device. A plurality of first fasteners is configured to couple to a surface of the vehicle. The first fasteners are positioned to couple to a respective cable such that the second end of the respective cable is positioned proximate to a passenger seat of the vehicle. A respective first connector is configured to selectively couple to the charging port of the electronic device to charge a battery of the electronic device.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a multi-device charging assembly according to an embodiment of the disclosure.

FIG. 2 is an in-use view of an embodiment of the disclosure.

FIG. 3 is an in-use view of an embodiment of the disclosure.

### DETAILED DESCRIPTION OF THE INVENTION

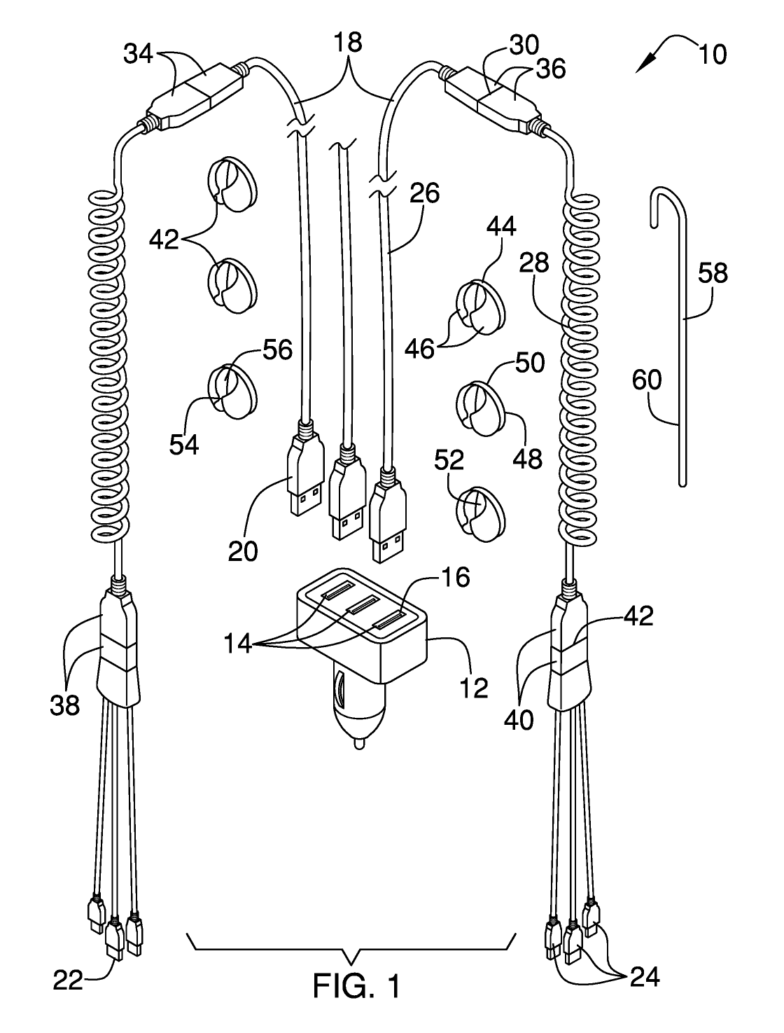

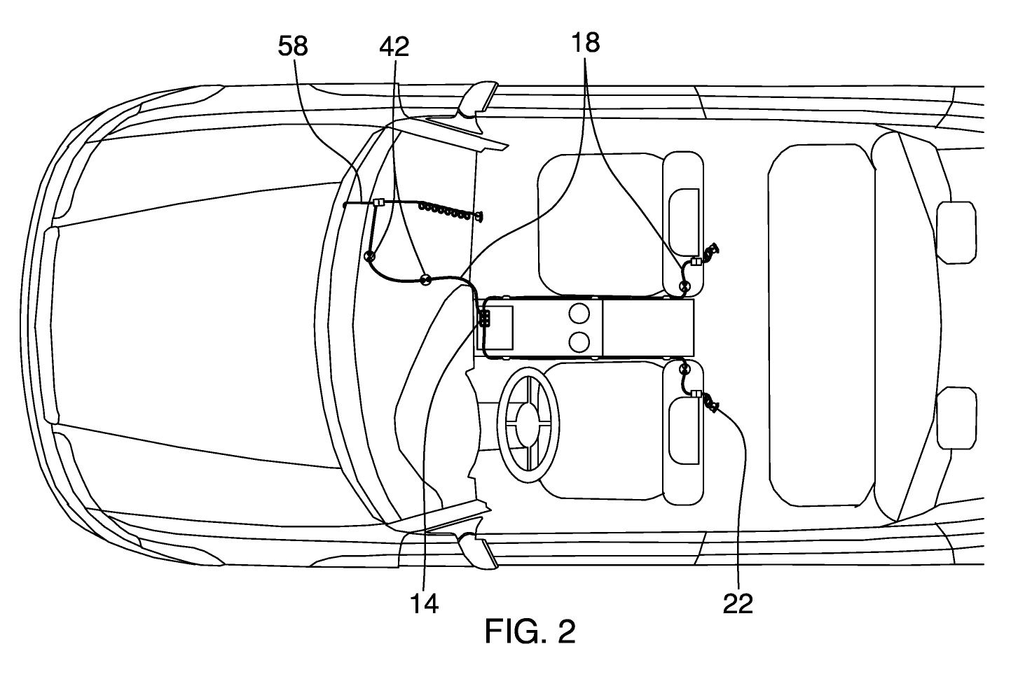

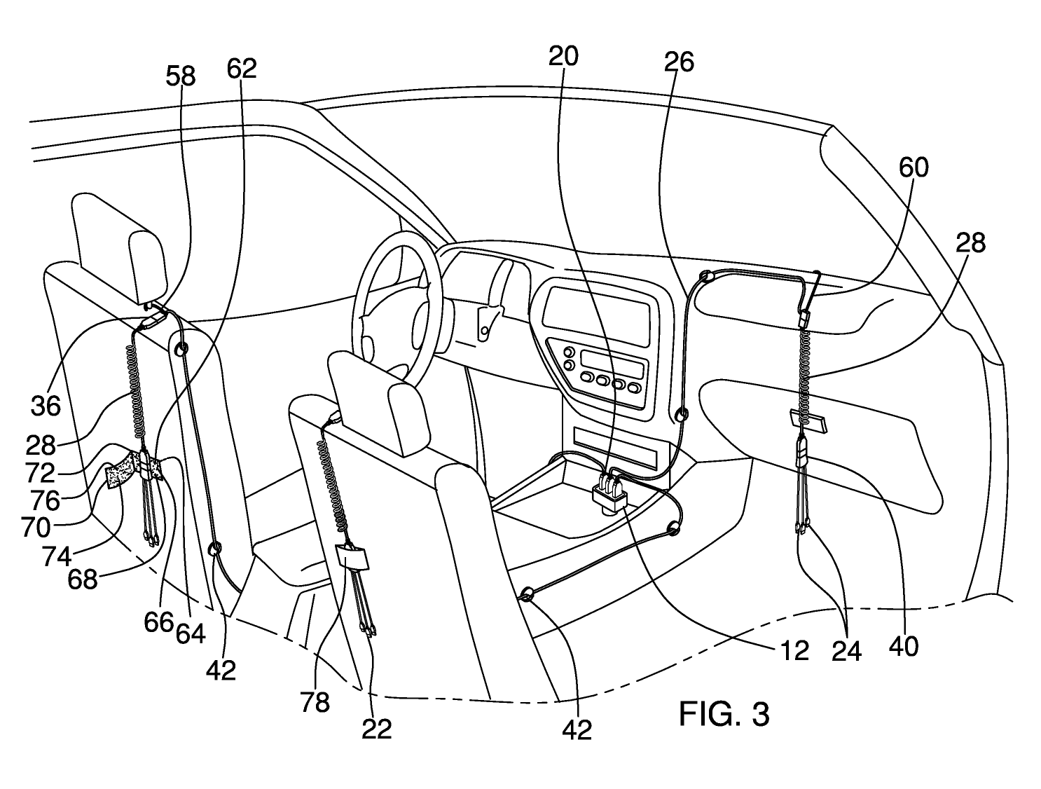

With reference now to the drawings, and in particular to FIGS. 1 through 3 thereof, a new charging assembly embodying the principles and concepts of an embodiment of the disclosure and generally designated by the reference numeral 10 will be described.

As best illustrated in FIGS. 1 through 3, the multi-device charging assembly 10 generally comprises an adaptor 12 that is configured to operationally couple to an electrical receptacle of a vehicle. In one embodiment, the adaptor 12 is complementary to a cigarette lighter receptacle and a 12 V auxiliary power outlet of the vehicle.

A plurality of ports 14 is positioned in the adaptor 12. In one embodiment, the ports 14 comprise Universal Serial Bus ports 16. In another embodiment, the plurality of ports 14 comprises from one to five ports 14. In yet another embodiment, the plurality of ports 14 comprises from two to four ports 14. In still yet another embodiment, the plurality of ports 14 comprises three ports 14.

The assembly 10 comprises a plurality of cables 18. Each cable 18 has a first end 20 that is configured to operationally couple to a respective port 14. Each cable 18 has a second end 22 that comprises a plurality of first connectors 24. Each first connector 24 is configured to couple to a charging port of an electronic device. In one embodiment, the plurality of cables 18 comprises three cables 18.

Each cable 18 comprises a first section 26 and a second section 28. The first section 26 extends from the first end 20 to a first endpoint 30. The second section 28 extends from the first endpoint 30 to a second endpoint 32. The second section 28 is coiled and resilient. The first section 26 of the cable 18 is configured to position between the electrical receptacle and an anchor point that is proximate to a respective passenger seat, such as a post of a headrest and a rim of a dashboard. The first endpoint 30 is positioned proximate to the anchor point. The second section 28 is configured to selectively reversibly extend between the anchor point and the charging port of the electronic device.

In one embodiment, the plurality of first connectors 24 comprises from one to eight first connectors 24. In another embodiment, the plurality of first connectors 24 comprises from two to six first connectors 24. In yet another embodiment, the plurality of first connectors 24 comprises three the first connectors 24.

In one embodiment, the assembly 10 comprises a plurality of second connectors 34. Each second connector 34 is coupled to and extends between the first section 26 and the second section 28 of a respective cable 18. The second connector 34 is positioned between the first section 26 and the second section 28 so that the second section 28 is selectively separable from the first section 26. In another embodiment, each second connector 34 comprises a first Universal Serial Bus connection 36.

In another embodiment, the assembly 10 comprises a plurality of third connectors 38. Each third connector 38 is coupled to and extends between the second section 28 of a respective cable 18 and a respective plurality of first connectors 24. The third connector 38 is positioned between the second section 28 and the respective plurality of first connectors 24 so that the respective plurality of first connectors 24 is selectively separable from the second section 28. The respective plurality of first connectors 24 is selectively changeable. In yet another embodiment, each third connector 38 comprises a second Universal Serial Bus connection 40.

The assembly 10 comprises a plurality of first fasteners 42. Each first fastener 42 is configured to couple to a surface of the vehicle, positioning the first fastener 42 to couple to a respective cable 18. The second end 22 of the respective cable 18 is positioned proximate to a passenger seat of the vehicle. The first connectors 24 are positioned on the cable 18 such that a respective first connector 24 is configured to selectively couple to the charging port of the electronic device of the user who is positioned in the passenger seat to charge a battery of the electronic device.

In one embodiment, each first fastener 42 comprises a disk 44 and a pair of tabs 46. The disk 44 is substantially circularly shaped. An adhesive 48 is coupled to a first face 50 of the disk 44. The adhesive 48 is configured to couple the disk 44 to the surface of the vehicle. Each tab 46 is coupled to and extends arcuately from a second face 52 of the disk 44. The pair of tabs 46 defines a slit 54 and a channel 56. The slit 54 is positioned to insert the respective cable 18 into the channel 56 to couple the respective cable 18 to the disk 44, such that the respective cable 18 is coupled to the surface of the vehicle.

The assembly 10 comprises a plurality of couplers 58. Each coupler 58 is positioned to selectively couple to the first section 26 of a respective cable 18 proximate to the first endpoint 30 of the first section 26. The coupler 58 is configured to couple to a respective anchor point. The first endpoint 30 is selectively fixedly positioned proximate to the anchor point, such as the post of the headrest and the rim of the dashboard. The second section 28 of the respective cable 18 is positioned to selectively reversibly extend between the anchor point and the charging port of the electronic device. In one embodiment, each coupler 58 comprises a wire 60 that is bendable.

In one embodiment, the assembly 10 comprises a plurality of first strips 62. Each first strip 62 has a first surface 64 that is configured to adhesively couple to a seat of the vehicle. Each of a plurality of second fasteners 66 is coupled to a second surface 68 of a respective first strip 62. Each of a plurality of second strips 70 is hingedly coupled to an edge 72 of an associated first strip 62. Each of a plurality of third fasteners 74 is coupled to an inner face 76 of a respective second strip 70. The third fasteners 74 are complementary to the second fasteners 66. The third fastener 74 is positioned to couple to an associated second fastener 66 to couple the respective second strip 70 to an associated first strip 62. An associated cable 18 is selectively couplable to the seat to stow the cable 18 when not in use. In another embodiment, the third fastener 74 and the associated second fastener 66 comprise a hook and loop fastener 78.

In use, the first section 26 of the cable 18 is configured to position between the electrical receptacle and the anchor point that is proximate to the respective passenger seat, such as the post of the headrest and the rim of the dashboard. The first endpoint 30 of the first section 26 is positioned proximate to the anchor point. The second section 28 of the cable 18 is configured to selectively reversibly extend between the anchor point and the charging port of the electronic device. The respective first connector 24 is configured to selectively couple to the charging port of the electronic device of the user who is positioned in the passenger seat to charge the battery of the electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multi-device charging assembly comprising:
an adaptor configured for operationally coupling to an electrical receptacle of a vehicle;
a plurality of ports positioned in said adaptor;
a plurality of cables, each said cable having a first end configured for operationally coupling to a respective said port, each said cable having a second end, said second end comprising a plurality of first connectors, each said first connector being configured for coupling to a charging port of an electronic device;
a plurality of first fasteners, each said first fastener being configured for coupling to a surface of the vehicle positioning said first fastener for coupling to a respective said cable such that said second end of said respective said cable is positioned proximate to a passenger seat of the vehicle; and
wherein said first connectors are positioned on said cable such that a respective said first connector is configured for selectively coupling to the charging port of the electronic device of the user positioned in the passenger seat to charge a battery of the electronic device.

2. The assembly of claim 1, further including said adaptor being complementary to a cigarette lighter receptacle and a 12 V auxiliary power outlet of the vehicle.

3. The assembly of claim 1, further including said ports comprising Universal Serial Bus ports.

4. The assembly of claim 1, further including said plurality of ports comprising from one to five said ports.

5. The assembly of claim 4, further including said plurality of ports comprising from two to four said ports.

6. The assembly of claim 5, further including said plurality of ports comprising three said ports.

7. The assembly of claim 1, further including said plurality of cables comprising three said cables.

8. The assembly of claim 1, further including each said cable comprising a first section and a second section, said first section extending from said first end to a first endpoint, said second section extending from said first endpoint to a second endpoint, said second section being coiled and resilient, wherein said first section of said cable is configured for positioning between the electrical receptacle and an anchor point that is proximate to a respective passenger seat, such as a post of a headrest and a rim of a dashboard, such that said first endpoint is positioned proximate to the anchor point, and wherein said second section is configured for selectively reversibly extending between the anchor point and the charging port of the electronic device.

9. The assembly of claim 1, further including said plurality of first connectors comprising from one to eight said first connectors.

10. The assembly of claim 9, further including said plurality of first connectors comprising from two to six said first connectors.

11. The assembly of claim 10, further including said plurality of first connectors comprising three said first connectors.

12. The assembly of claim 8, further including a plurality of second connectors, each said second connector being coupled to and extending between said first section and said second section of a respective said cable, wherein said second connector is positioned between said first section and said second section such that said second section is selectively separable from said first section.

13. The assembly of claim 12, further including each said second connector comprising a first Universal Serial Bus connection.

14. The assembly of claim 8, further including a plurality of third connectors, each said third connector being coupled to and extending between said second section of a respective said cable and a respective said plurality of first connectors, wherein said third connector is positioned between said second section and said respective said plurality of first connectors such that said respective said plurality of first connectors is selectively separable from said second section such that said respective said plurality of first connectors is selectively changeable.

15. The assembly of claim 14, further including each said third connector comprising a second Universal Serial Bus connection.

16. The assembly of claim 1, further including each said first fastener comprising:
a disk, said disk being substantially circularly shaped;
an adhesive coupled to a first face of said disk, wherein said adhesive is positioned on said first face such that said adhesive is configured for coupling said disk to the surface of the vehicle;
a pair of tabs coupled to and extending arcuately from a second face of said disk defining a slit and a channel; and
wherein said slit is positioned for inserting said respective said cable into said channel to couple said respective said cable to said disk such that said respective said cable is coupled to the surface of the vehicle.

17. The assembly of claim 8, further including a plurality of couplers, each said coupler being positioned for selectively coupling to said first section of a respective said cable proximate to said first endpoint of said first section, said coupler being configured for coupling to a respective anchor point such that said first endpoint is selectively fixedly positioned proximate to the anchor point, such as the post of the headrest and the rim of the dashboard, positioning said second section of said respective said cable for selectively reversibly extending between the anchor point and the charging port of the electronic device.

18. The assembly of claim 17, further including each said coupler comprising a wire, said wire being bendable.

19. The assembly of claim 1, further comprising:
a plurality of first strips, each said first strip having a first surface configured for adhesively coupling to a seat of the vehicle;
a plurality of second fasteners, each said second fastener being coupled to a second surface of said first strip;
a plurality of second strips, each said second strip being hingedly coupled to an edge of an associated said first strip;
a plurality of third fasteners, said third fasteners being complementary to said second fasteners, each said third fastener being coupled to an inner face of a respective said second strip, said third fastener and said associated said second fastener comprising a hook and loop fastener; and
wherein said third fastener is positioned on said respective said second strip such that said third fastener is positioned for coupling to an associated said second fastener to couple said respective said second strip to an associated said first strip, such that an associated said cable is selectively couplable to the seat for stowing when not in use.

20. A multi-device charging assembly comprising:
an adaptor configured for operationally coupling to an electrical receptacle of a vehicle, said adaptor being complementary to a cigarette lighter receptacle and a 12 V auxiliary power outlet of the vehicle;
a plurality of ports positioned in said adaptor, said ports comprising Universal Serial Bus ports, said plurality of ports comprising from one to five said ports, said plurality of ports comprising from two to four said ports, said plurality of ports comprising three said ports;
a plurality of cables, each said cable having a first end configured for operationally coupling to a respective said port, each said cable having a second end, said second end comprising a plurality of first connectors, each said first connector being configured for coupling to a charging port of an electronic device, said plurality of cables comprising three said cables, each said cable comprising a first section and a second section, said first section extending from said first end to a first endpoint, said second section extending from said first endpoint to a second endpoint, said second section being coiled and resilient, wherein said first section of said cable is configured for positioning between the electrical receptacle and an anchor point that is proximate to a respective passenger seat, such as a post of a headrest and a rim of a dashboard, such that said first endpoint is positioned proximate to the anchor point, and wherein said second section is configured for selectively reversibly extending between the anchor point and the charging port of the electronic device, said plurality of first connectors comprising from one to eight said first connectors, said plurality of first connectors comprising from two to six said first connectors, said plurality of first connectors comprising three said first connectors;
a plurality of second connectors, each said second connector being coupled to and extending between said first section and said second section of a respective said cable, wherein said second connector is positioned between said first section and said second section such that said second section is selectively separable from said first section, each said second connector comprising a first Universal Serial Bus connection;
a plurality of third connectors, each said third connector being coupled to and extending between said second section of a respective said cable and a respective said plurality of first connectors, wherein said third connector is positioned between said second section and said respective said plurality of first connectors such that said respective said plurality of first connectors is selectively separable from said second section such that said respective said plurality of first connectors is selectively changeable, each said third connector comprising a second Universal Serial Bus connection;
a plurality of first fasteners, each said first fastener being configured for coupling to a surface of the vehicle positioning said first fastener for coupling to a respective said cable such that said second end of said respective said cable is positioned proximate to a passenger seat of the vehicle, wherein said first connectors are positioned on said cable such that a respective said first connector is configured for selectively coupling to the charging port of the electronic device of the user positioned in the passenger seat to charge a battery of the electronic device, each said first fastener comprising:
a disk, said disk being substantially circularly shaped,
an adhesive coupled to a first face of said disk, wherein said adhesive is positioned on said first face such that said adhesive is configured for coupling said disk to the surface of the vehicle, and
a pair of tabs coupled to and extending arcuately from a second face of said disk defining a slit and a channel, wherein said slit is positioned for inserting said respective said cable into said channel to couple said respective said cable to said disk such that said respective said cable is coupled to the surface of the vehicle;
a plurality of couplers, each said coupler being positioned for selectively coupling to said first section of a respective said cable proximate to said first endpoint of said first section, said coupler being configured for coupling to a respective anchor point such that said first endpoint is selectively fixedly positioned proximate to the anchor point, such as the post of the headrest and the rim of the dashboard, positioning said second section of said respective said cable for selectively reversibly extending between the anchor point and the charging port of the electronic device, each said coupler comprising a wire, said wire being bendable;
a plurality of first strips, each said first strip having a first surface configured for adhesively coupling to a seat of the vehicle;
a plurality of second fasteners, each said second fastener being coupled to a second surface of said first strip;
a plurality of second strips, each said second strip being hingedly coupled to an edge of an associated said first strip;
a plurality of third fasteners, said third fasteners being complementary to said second fasteners, each said third fastener being coupled to an inner face of a respective said second strip, wherein said third fastener is positioned on said respective said second strip such that said third fastener is positioned for coupling to an associated said second fastener to couple said respective said second strip to an associated said first strip, such that an associated said cable is selectively couplable to the seat for stowing when not in use, said third fastener and said associated said second fastener comprising a hook and loop fastener; and
wherein said first section of said cable is configured for positioning between the electrical receptacle and the anchor point that is proximate to the respective passenger seat, such as the post of the headrest and the rim of the dashboard, such that said first endpoint is positioned proximate to the anchor point, and wherein said second section is configured for selectively reversibly extending between the anchor point and the charging port of the electronic device, such that said first connectors are positioned on said cable such that said respective said first connector is configured for selectively coupling to the charging port of the electronic device of the user positioned in the passenger seat to charge the battery of the electronic device.
